(19) United States
(12) Patent Application Publication
(10) Pub. No.: US 2009/0037274 A1
(43) Pub. Date: Feb. 5, 2009

(54) Electronic coupon redemption utilizing RFID key ring scan, magnetic swipe card and credit card processed by processing terminal with automated coupon verification, demographic collection and storage, consumer information collection device

(76) Inventor: Michael Yaccarino, Brick, NJ (US)

Correspondence Address: Michael Yaccarino, 250 Melrose Street, Brick, NJ, 08724, US

(21) Appl. No.: 11/888,328

(22) Filed: Jul. 31, 2007

(51) Int. Cl. G06Q 30/00; G06Q 99/00

(52) U.S. Cl. 705/14; 705/1

(57) ABSTRACT

Portable or stationary collection device for collection of consumer information and coupon club sign up. A collection device one or several in number that is hand held for the collection of consumer information and capable of transfer of data by utilizing wired or wireless technology to a centralized computer which puts consumer information into a data base for later use in the coupon process. Electronic coupons sent by e mail, cell phone or taken off the internet or intranet, redeemed and verified by swiping a credit card into a credit card processing terminal, reading of a RFID key ring, read of a magnetic swipe card by a matching processing terminal. Special coupon numbering received by cell phone coupon and redeemed by punching number into a credit card terminal.

This application claims propriety of provisional application Serial # EQ 47066962US filed on Jul. 31, 2006

### FIELD OF THE INVENTION

This invention relates to generating and redeeming coupons and using processing terminals to automate the redemption process.

### PRIOR ART

Discount coupons have long been distributed by manufacturers to market their products and by retail stores to attract consumers to their particular stores. Electronic coupons sent electronically by e mail or taken from the internet and printed using the consumer's computer and printer printed are still paper. Taken the paper coupon to a redemption center, such as a retail store, and redeemed for some value or as a discount toward the purchase of some item still has the problems paper coupons present. While this method has proven to be effective, there are many disadvantages to the process for the user and for the redemption center and retail store, as well as for the advertisers themselves as the coupon is still paper when submitted for redemption. Bar code coupons or coupons which display a barcode that can be scanned at the point of purchase still is in a paper form and suffers all the disadvantages of a paper coupon. Computer generated and computer redeemable coupons still have the disadvantage of not using a processing terminal. The portable scanning device for customers to carry multiple magnetic media and barcode based plastic cards presents problems as they are expensive and call for a whole new network to be developed by the retailer. They must be carried by the consumer and are awkward to transport and use. They are prone to all the failures and problems of a commercially used piece of electronics such as dirty contacts and battery failure. The card writing device and accompanying smart card used electronics for coupon redemption using bar codes and has the problems of expense of infrastructure necessary to setup and make the system work also system failure. Using this method the customer is credited with the value of a coupon when UPC data from a bar code reader corresponds to a coupon stored on the card at checkout. The use of barcodes in this fashion lends itself to an electronic dilemma in programming the card for use by the consumer. They are due to failure caused by interference of EMI and other signal interference. The consumer must also sing up to receive the card and then program the card and carry it for use in a system that the retailer must purchase special hardware for use of this system. Each cash register station must be outfitted with an electromagnetic detector to detect cards and their coupons at a huge cost to merchants. The sale or coupon items must also be scanned leading to wasted time by both store employees and consumers alike. Other electronic coupons call for a clearing fee adding cost to goods and services.

The problem associated with electronically sent and computer printed or clipping coupons by a user are numerous. First, a user must search the internet, download the coupon then print the coupon or purchase or otherwise obtain a publication, and search through such publication for coupons which would be useful or meaningful to the user. The user then must cut out such coupons being of various sizes and shapes, leaving a pile of scrap paper and holes in the pages of the publication. Some advertisers use handouts or flyers which make the searching job easier, but there is still the problem of cutting out of the coupons which is annoying and a waste of valuable time. Being of different sizes and pertaining to different types of products, the user must separate the coupons into product categories and band the coupons together in the best way possible. The user then stuffs these sorted coupons into a pocket or purse and is off to the market. Upon arrival at a particular market outlet, the user usually fumbles through his or her coupons and attempts to find the products in the store. Furthermore, in order to redeem some coupons, the user may find it necessary to search out the desirable item in a number of stores. Finally, upon gathering the products into the pushcart, the user has yet another manipulation to make, i.e. he or she must select the coupons for which the products are purchased from a number of coupons the user bought to the store initially.

This then leads to the next problem associated with coupon redemption. After the customer leaves, the retail store is still not relieved from further expenditure of valuable employee time, since the accumulated coupons in the retail store must be sorted by manufacturer for retail store reimbursement.

Insofar as the manufacturer of the product is concerned, while there is direct evidence that consumers are reading their ads and using coupons, and the number of coupons coming back to the manufacturer indicates some level of success in advertising, there is very little additional marketing information that can be derived from this type of coupon redemption scheme. The manufacturer has no information which would be of great value to the manufacturer in planning future advertising programs. Since some coupons are submitted anonymously, the manufacturer does not know how to reach that person again for arousing interest in related products. While some demographic information can be obtained by noting the geographical regions in which the coupons were redeemed, the lack of any specific information as to the nature of the purchaser leads many manufacturers to conduct separate marketing surveys which are extremely costly and time consuming. Some manufacturers are known to have spent millions of dollars to gather such information.

The present electronic Coupon are still submitted in a paper form and has all the fall backs of the paper cut coupons and more. There is still the fumbling with coupons while shopping to contend with along with the valuable time of store personnel wasted while accepting and cataloging the coupons.

Moreover, the current system of clearing coupons which are distributed and redeemed usually involves physically sending redeemed coupons to a clearing house. The clearing house returns the coupons to the manufacturer (issuer) and issues debits and credits to the manufacturer and retailer, or factors coupons for the retailer. This physical handling of coupons is expensive, cumbersome, error prone, slow and subject to manipulation.

It can therefore be appreciated that there are many problems associated with existing coupon redemption programs, and the drawbacks of these systems are numerous and disliked by all three entities involved, the consumer, the redemption center (retail outlet store) and the manufacturer.

### SUMMARY OF MY INVENTION

The prior art falls far short and fails to utilize the already existing extensive network utilized by the current improvement that uses infrastructure already in place in retail establishments both small and large globally. Present electronic coupons call for an infrastructure of hardware to be placed in the hands of consumers and merchants at great expense and are not user friendly. My invention takes advantage of billions of dollar of networks and hardware with the patent sought after building a global machine that is most economical and extremely useful and user friendly. All components of the sought after invention are used in every day shopping and consumers and retailers are familiar with their functions and use.

The inventions use of public computer networks such as the Internet and Magnetic Swipe Card, RFID tagging, Credit Card Terminals and Credit Cards along with cell Phones offer many benefits and compensation compared to the present day means for generating and redeeming coupons. Utilizing existing hardware along with specialized software creates a far better coupon generation, collection, verification, retail sorting and clearing and redemption system far beyond what is presently offered. The hand held electronic collection device used for the collection of information and its ability to download this information into a central computer dose away with retailers distributing paper forms to be filled out by consumers. Several hand held collection devices could be used in restaurant and when keyed send collected consumer information to a central computer. The data collected in the central computer would be used for coupon distribution to customers who wish to receive these offers.

This new process and machine overcomes the deficiencies and disadvantages of current coupon distribution and redemption systems. Use of terminal scanning technology for coupon redemption saves man hours, paper and is easy to use for shoppers.

The creation of secrete or hidden coupon appeals to a huge, vastly untapped male market. Because of the male bravado most men look at the paper coupon as an embarrassment. There is an underlying desire in the male market to use coupons and secrete or hidden coupon which show no appearance in public of use and would be readily accepted by men.

Still other embellishments of the invention include, but are not limited to the following:

a portable collection device that can be one or several comprised of a computer, screen and keyboard that can transfer data collected to a central computer using wired or wireless technology that is presently commercially available.

a stationary collection device comprised of a computer, screen and keyboard in a flat screen or kiosk configuration that can transfer data collected to a central computer using wired or wireless technology that is commercially available.

a collection device comprised of a computer and database that runs a special attention getting screen and prompts the consumer to input their information. This device can be a flat screen or kiosk configuration for easy store placement.

a process that allows a consumer can select coupons using a computer and their e mail program. They can contact a company Internet or Intranet to select coupon. Once a selection is made choices is then recorder so when the consumer uses their Magnetic Swipe card, RFID Tag or Credit Card in a matching terminal the coupon can be redeemed. The consumer also has the ability to print a shopping list of chosen offers and coupons.

a process by which a consumer can sign up for a company's coupon program and then receive e mails of coupon offers. When e mail coupons are received the consumer chooses the ones desired by placing a check next to them. When finished selection is returned to the store or credit card internet or intranet and awaits redemption by the consumer.

a process by which generation of coupons with unique serial numbers including coupon's serial number and user's identification number in the coupon database.

a process that allows secret or hidden coupon that can be used in a private manner.

a process by which for easy verification of coupons is achieved in the distributors or manufactures Internet or Intranet database by comparison of consumer's electronically generated and redeemed coupon or other expression of coupon's serial number, and the coupon data stored on the Internet or Intranet.

a process by for coupon distribution and redemption system which can identify users of the system before they make coupon selections and offer different coupons to different users of the system before they make coupon selections on the basis of already-obtained demographic data about the users.

a process to provide a coupon distribution and redemption by which consumer could visit a Credit Card maintained site be it internet or intranet and using their zip code be provided with a list of offers by local merchants in that chosen geographical area. The consumer could than check off their desired offers and their choices would be recorded. Redemption would take place when the consumers Credit Card is processed at the merchants credit card terminal. The coupon value adjustment and calculation of tax would take place in an unnoticed and secret manner.

a process by which coupons are entirely electronic form providing for electronic redemption at the retail outlet, and electronic storage in the memory of the user's general computing device.

a process by which collection device comprised of a computer, screen, keyboard having a specialized looped program that entices the consumer to input their personal information. It can be a flat screen computer, laptop or specialized kiosk.

a process by which portable stand alone collection device comprised of a computer or e prom chip, screen, keyboard, memory and a communication port or wired or wireless data transfer means. This portable device can be like a blackberry and is easy and inexpensive to make. Using this portable collection device a waiter or other store employee could use collect patron information for store coupon or club membership. Information would become a database for send coupons.

a process by which coupons could be sent to the consumer's cell phone and redeemed by showing the cell phone screen to merchant personnel at checkout or by paying the bill with a credit card, RFID Key Ring or magnetic card swiping method or putting in a coupon number into the credit card processing terminal or cash register could also be a part of this process.

a process by which during off peak hours or when business is slow, merchants using the Credit Card maintained web or intranet site would have the ability to post instant timely coupons that would be delivered swiftly by telephone to the consumer's cell phone. Redemption would take place when the consumers Credit Card is processed at the merchant's credit card terminal, RFID key ring or magnetic card swiping method or putting in a coupon number into the credit card processing terminal or cash register. The coupon value adjustment and calculation of tax would take place in an unnoticed and secret manner.

a process by which a consumer could go to credit card company web site and there put in a location or zip code and view coupon offers or receive an e mail of merchants who have specials or coupon offers in that chosen area. The consumer would then go to the participating merchants store and the coupon or special would be collected by simply using the credit card, the appropriate coupon amount and tax would be adjusted accordingly. This would take place due to the credit card processing terminals connection with the credit cards secure intranet. It may also be possible to redeem the coupon by use of Magnetic key ring swipe card, RFID technology, bandwidth from 1 MHz to 5 GHz including WI-FI or any other wire or wireless connections and an Internet or Intranet link at the merchant point of sale

### BRIEF DESCRIPTION OF DRAWING

FIG. 1

Coupon Verification, Demographic Collection and storage, Redeemable by Magnetic Card or RFID Key Ring
1. Information Collection Device—Merchant utilizes a laptop or dedicated piece or electronic kiosk or hand held device to collect client information. Collection can also be inputted by consumer at merchant web site or intranet. The cash register can also be used
2. Consumers Computer and Printer—Consume receives e mail with multiple offers, consumer then checks off desired coupons and hits submit or sends e-mail back to merchant. Consumer can use their printer to print out a list of coupons they chose if so desired.
3. Store Internet or Intranet—Merchant intranet or internet sends coupons to consumer's computer and stores demographics collected on consumer purchase habits. Validates coupons and acts as a hub for coupon processing
4. Store Check Out with RDFI or Magnetic Card ID Tag Scanner—Magnetic card or RFID enters coupon information into the system. Utilizing internet or intranet to obtains coupon is validates, bill is adjusted and demographics are stored

FIG. 2

Credit Card Coupon Verification, Bill adjustment and Demographic Collection and Storage
5. Credit Card Web Site—Credit card web site may be internet or intranet and part of the credit card processing terminal and system.
6. Consumers Computer—Consumer can use printer to print list of coupons chosen.
7. Point of Purchase Credit Card Terminal—Used to process credit cards at merchants business
8. Credit Card Secure Intranet or Internet—This is where credit card information is held and used to verify credit card validity
9. Merchant RDFI or Magnetic Card ID Tag Scanner—Used to identify consumer in system and check coupon status.

FIG. 3

Express Coupon Delivery to Cell Phone
10. Web Site or Intranet—Can be credit Card company maintained or merchant.
11. Cell Phone—Consumers cell phone screen is used to display coupon.
12. Merchant RDFI or Magnetic Card ID Tag Scanner—Can be linked to credit card internet or intranet and processing terminal.

FIG. 4

Portable Information Collection Device
13. Portable Collection Device—Hand held computer with screen and keyboard numbering one or several. Data transfer ability by commercially available wired or wireless means
14. Merchants Central Computer—Desktop or laptop with the ability to receive data transfer by commercially available wired or wireless means.

FIG. 5

Coupon Verification, Demographic Collection and Storage, Redeemable by Magnetic Swipe ID Card or RFID ID Key Ring or RFID ID Card, Credit Card and Processing Terminal and Cell Phones
100. Consumers printer and printer
101. Web Site
102. Intranet
103. Database
104. Point of Purchase, “POP”.
105. RFID Scanner Magnetic Swipe Card Cash Register Credit Card Terminal

### DETAILED DESCRIPTION OF INVENTION

A point of purchase information collection device would be used to collect consumer information and coupon club membership. The collection devices can be stationary computer, kiosk, or hand held device one or several in number or an internet or intranet site. Information collected would be stored in a database. Stationary or hand held collection devices would use a wire or wireless connection to transfer data to a central master computer for later use.

After the above sign up or collection of consumer information consumers would start receiving e mails from merchants that contained coupon offers on their computer. Consumes would then check the coupons received by e mail they desire and hit a submit button. A print out could be made on the consumers printer of coupons chosen. The choices would be returned to the sender and stored in a database linked to merchants processing terminal that scans RFID cards or tags, Credit Cards or other magnetic swipe cards.

Redemption of coupons will take place at the point of sales by use of a matching processing terminal for magnetic swipe card, read of a RFID Tag or punching a coupon number into the cash register. The merchants processing terminal and cash register is hooked to a business internet or intranet and would identify consumer, redeem coupons, collect demographics and adjust bill to reflect coupon savings. Information would be stored in a database.

Credit Card Companies would maintain a wed site or intranet site where merchants entering their ID and password could then place their coupon offers using a computer or connected to the internet. The consumer using their computer with an internet connection and a browser along with their password and Id could sign in and search the credit card company web site for coupon and offers by zip code. A search for coupons offered by merchant using a zip code would bring up another page with results of merchant coupon offers in the chosen zip code area. The consumer would then check the coupons they desired and click a submit button. Their choices would be recorded in the credit card company database that is linked to merchant's card processing terminals. Coupons would be redeemable when the consumer uses their credit card at the point of purchase when the credit card is swiped past the credit card terminal or by swiping a magnetic swipe card, electronic read of a RFID Tag using a matching processing terminal. The terminal would connect to the credit cards database identify the consumer and their information and coupon. The terminal would then receive adjustment to the bill made to reflect the coupon discount and state tax adjusted accordingly. The bill would be printed showing the coupon savings ready to be signed by the consumer. Verification of the offer would also have take place and demographics collected.

Express coupon is a coupon that is timely only good for a short period of time and used by business to generate off hour business. Once the consumer signs up for the express coupon online or at point of purchase or during the initial sign up coupons would be received by telephone an be viewable on the consumers cell phones screen. The consumer would only have to show the waitress or store clerk the offer on the cell phone screen to take advantage of the cell phone coupon, a bare code could also be displayed for scanning purpose. The coupon would be redeemed also by swiping a magnetic swipe card, electronic read of a RFID Tag or use of their credit card when used in a matching processing terminal. This would initiate a search the database that would identify the consumer and the terminal verify the coupon and initiate a search of the consumer's records and return coupon or coupons chosen and adjust the bill accordingly. The redemption could also be initiated by use of a special coupon number displayed on the cell phone, punched into the credit card processing terminal or a cash register. Then an adjustment to the bill would be made to reflect the coupon discount and state tax adjustment, verification of the offer would also take place and demographics be collected.

In larger retailers who use many coupons they would be collected, sorted and stored automatically and electronically in a computers database for store clearing of manufacturer's coupons in an automatic fashion.

DETAILED DESCRIPTION OF DRAWING

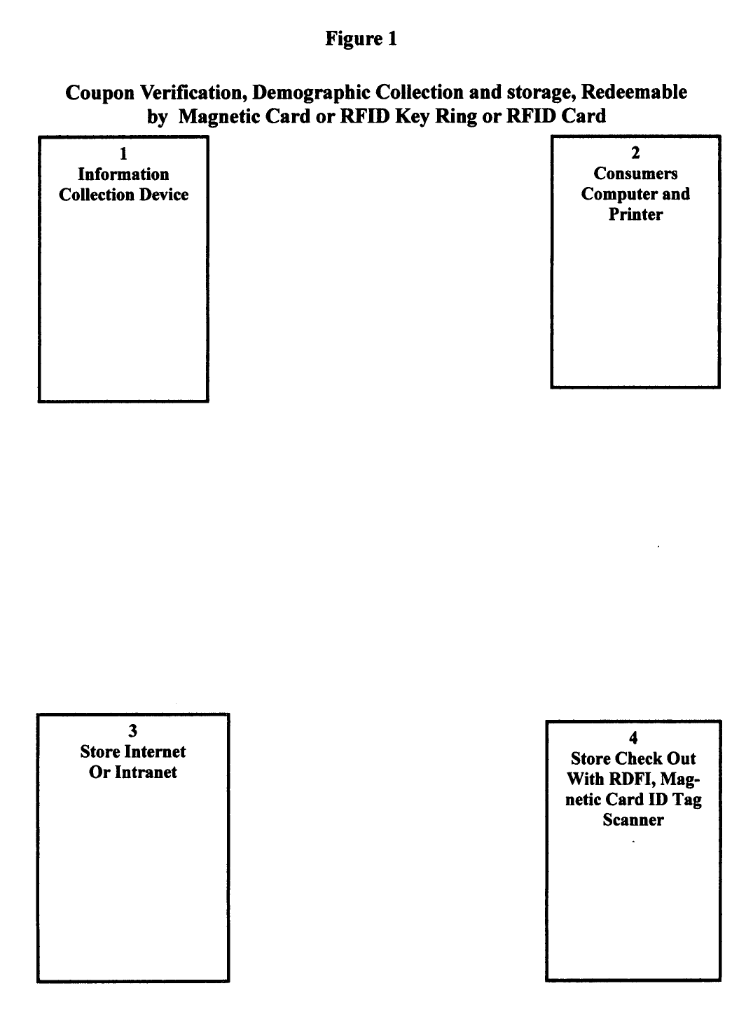

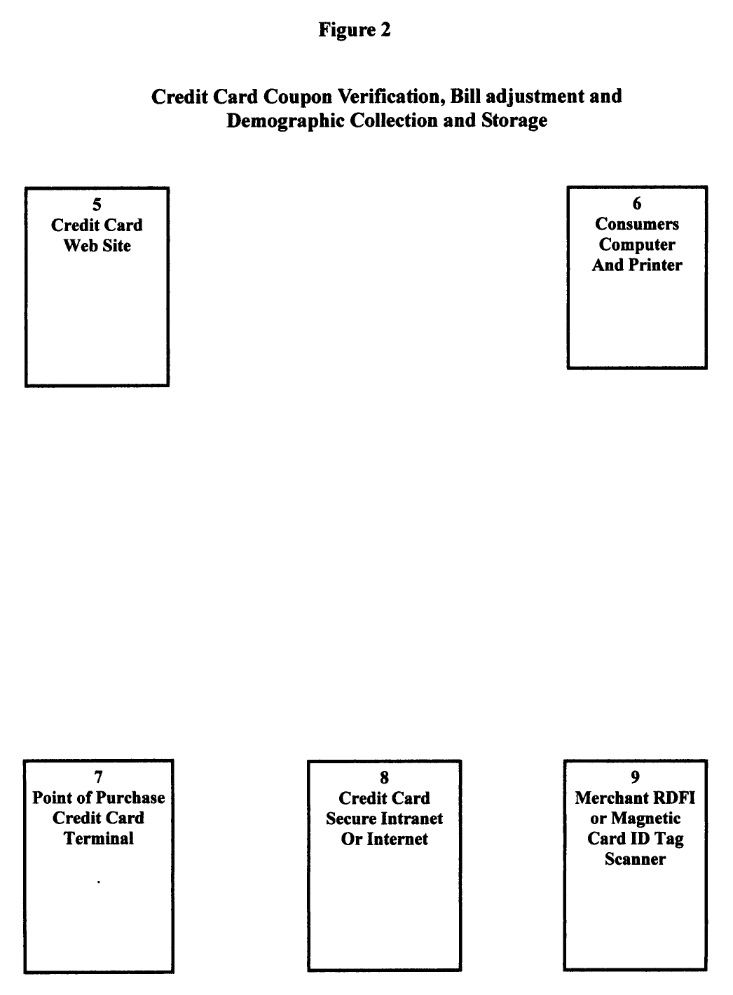

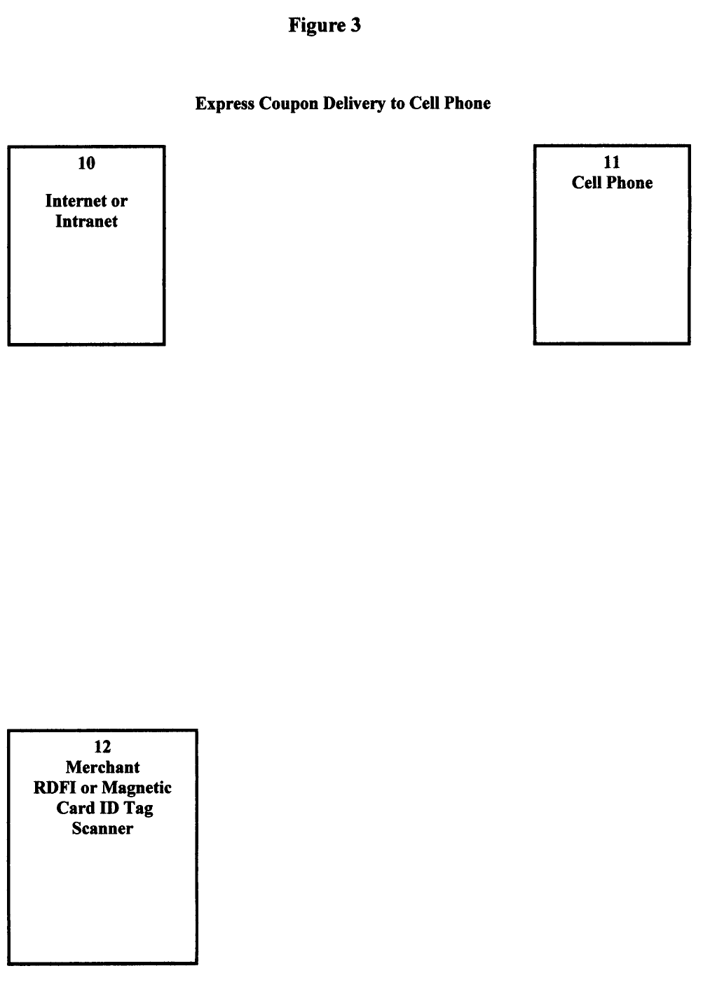

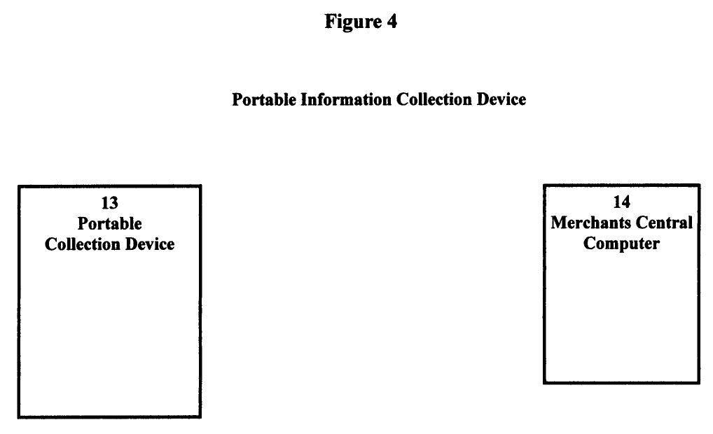

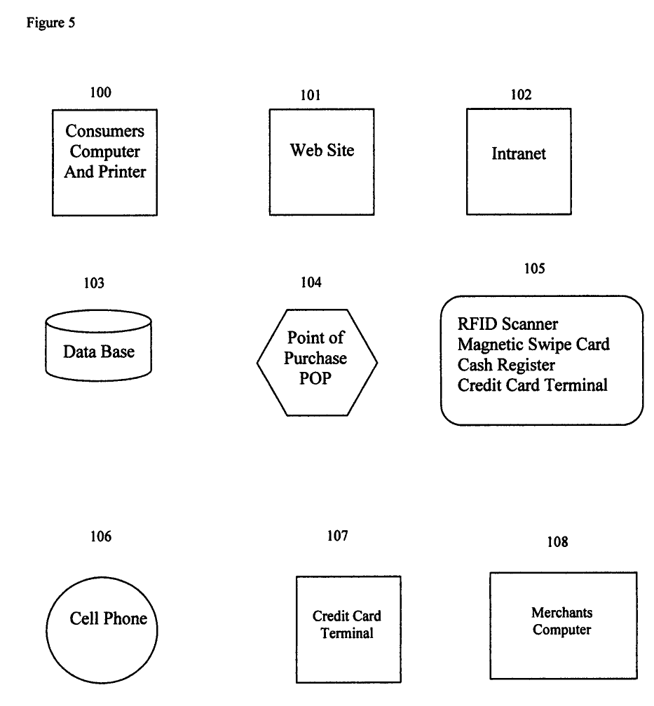

FIG. 1—Coupon Verification, Demographic Collection and Storage, Redeemable by Magnetic Card or RFID Key Ring

Consumer signs up and inputs personal information at collection device 1. or at corporate web site or intranet 3.

Coupons are sent to consumer's computer 2 by e mail from store intranet or internet 3. Consumer chooses coupons by checking boxes in e mail. Choices are sent back to store internet or intranet 3 where they are recorded. List of chosen coupons can then be printed on consumers printer hooked to computer 2.

At store check out 4 magnetic card or RFID is scanned. Utilizing merchant intranet or internet 3 electronic coupons is then verified demographics are stored. Bill is reduced accordingly at store checkout 4.

FIG. 2—Credit Card Coupon Verification, Bill Adjustment and Demographic Collection and Storage

Consumers using their computer 6, to connect to Credit Card Company web site 5, then signs up for coupon program.

After initial sign up consume can use Credit Card Company web site 5 and inputs a desired zip code in a search for coupon offers. After entering a zip code, a list of participating merchant in that area and discount coupon and offers are displayed. Consumer then checks desired coupons and offers, choices and used information are recorded and sent to Credit Card Intranet 8. Selected offers can be printed by printer attached to consumer's printer 6.

When consumer uses credit card at 7, Point of Purchase Credit Card is swiped, terminal connects to credit card intranet or internet 8, coupon is verified, and demographics are recorded. Coupon discount is then sent back to Point of Purchase terminal 7, where coupon discount is applied to total and tax adjusted accordingly, receipt is then printed for consumer approval and signature.

Redemption can also be accomplished with use of RFID and magnetic card key ring technology 9 that would integrate into the above.

FIG. 3—Express Coupon Delivery to Cell Phone

When business is slow merchant can use internet or intranet site 10, to create an express coupon for prompt distribution by telephone to customers.

Once merchant places an express coupon on the internet or intranet 10, express coupon is delivered using telephone service to 11, consumer's cell phone.

Consumer receives coupon by phone 11, looks at screen and decides to use coupon Coupon is redeemed by consumer at merchant 12, by simply showing screen with coupon or when paying by credit card optionally by scanning consumers RFID or magnetic key ring tag.

Coupon verification and demographics are collected when RFID or magnetic key ring ID card is scanned or when paying by credit card 12, and stored at website intranet site 10.

FIG. 4—Portable Information Collection Device

Consumer information is collected using 13, which could be one or several portable collection devices.

When device 13, is keyed or automatically, stored information on portable collection device numbering one or several is sent to 14, central computer by use of any wired or wireless commercially available transfer means for storage in central computer for later use of information.

FIG. 5

Coupon Verification, Demographic Collection and storage, Redeemable by Magnetic Swipe ID Card or RFID ID Key Ring or RFID ID Card, Credit Card and Processing Terminal and Cell Phones

Consumer using the internet and their computer 100 connects to website 101 and signs up for coupon program. Data of sign up is stored in business database 103 which can reside in either 101 or 102. Coupons are e mailed to consumer's computer 100. When consumer using their computer 100, receives and reads e mail with coupons displayed, desired coupons are checked off and submitted back to source, a print out of chosen coupons using the attached printer is possible. Selections submitted by e mail using consumer's computer 100 are stored in database 103 which could reside at either 101 or 102. Redemption of coupon listed in printout takes place at 104 POP checkouts. Redemption is automated by use of 105 when magnetic swipe ID card or RFID ID key Ring or RFID ID card is used. The right hardware 105 scans a matching ID tags, “(RFID hardware scans RFID ID)”, and connects to the database 103 using an internet or intranet connection for customer identification, coupon redemption and verification. Discounts by internet or intranet are sent to the cash register 104 where bill is adjusted automatically to reflect the coupons chosen by consumer.

Coupon redemption using 107, a credit card terminal takes place as follows. Credit card companies storing coupons in their data base 103. When the credit card is scanned using a credit card terminal 107 at POP 104, the credit card data base is contacted and user is identified then the coupon is verified, collection of consumer demographics take place then coupon savings is sent to 107 credit card terminal where printed receipt reflecting the savings along with adjusted sales tax to reflect the coupon savings.

### Coupon Generation, Delivery and Redemption

When business is slow the business owner or personnel using an ID number and password can sign onto web site 101 or 102, generate and post an express coupon using 108 the merchant's computer. The coupon will reside in data base 103. This express coupon will have a self delete program that will execute at a time chosen by the merchant when placing coupon on 101 web site. This delegation will delete the coupon from database 103. Delivery of express coupon will take place by telephone call from an automated system at 101 or 102 to consumer's cell phone 106. Redemption of express coupons can take place by they following.

When the credit card is scanned using a credit card terminal 107 at POP 104, the credit card data base is contacted and user is identified then the coupon is verified, collection of consumer demographics take place then coupon savings is sent to 107 credit card terminal where printed receipt reflects the savings along with adjusted sales tax to reflect the coupon savings. Redemption can also take place by use of a coupon umber sent to cell phone 105, that is punched into the credit card terminal 107 or cash register 104 that is hooked to the a web site 101, or intranet 102.

Redemption is automated by use of 105 when magnetic swipe ID card or RFID ID key Ring or RFID ID card is used. The right hardware 105 scans a matching ID tags, “(RFID hardware scans RFID ID)”, and connects to the database 103 using an internet or intranet connection for customer identification, coupon redemption and verification. Discounts by internet or intranet are sent to the cash register 104 where bill is adjusted automatically to reflect the coupons chosen by consumer.

1. The machine that is built using new software and existing hardware that allow magnetic cards, RFID tags and cell phones to interact with processing terminals and databases for the purpose of cashing and verifying electronic coupons and collection of consumer demographics.

2. A device made up of new software and existing hardware that allows simple collection of consumer information.

3. A system and method that uses new software which allows electronic coupons to be stored, verified, redeemed and demographics collected using hardware presently used to process credit cards.
